(19) United States
(12) Patent Application Publication
(10) Pub. No.: US 2009/0038074 A1
(43) Pub. Date: Feb. 12, 2009

(54) Hospital Bed with Double-Motor Drive

(76) Inventor: Hans-Peter Barthelt, Esslingen (DE)

Correspondence Address: LEYDIG VOIT & MAYER, LTD, TWO PRUDENTIAL PLAZA, SUITE 4900, 180 NORTH STETSON AVENUE, CHICAGO, IL, 60601-6731, US

(21) Appl. No.: 11/918,910

(22) PCT Filed: Mar. 23, 2006
(86) PCT No.: PCT/EP2006/002652

§ 371 Date: Nov. 19, 2007

(30) Foreign Application Priority Data
Apr. 21, 2005 (DE) 10 2005 018 686.6

(51) Int. Cl. A61G 7/018; A61G 7/015

(52) U.S. Cl. 5/611; 5/616

(57) ABSTRACT

The invention provides a hospital bed with two driving motors that are used in the vertically adjustable jack in order to increase the hoisting power of the bed so as to be able to lift heavy patients. The two driving motors are mounted so as to mechanically operate in parallel. In order to obtain a symmetric load distribution among the two motors, the motors are electrically connected in series and are supplied from a joint voltage source as a serial connection.

### FIELD OF THE INVENTION

This invention relates to adjustable hospital beds.

### BACKGROUND OF THE INVENTION

In DE 10 2004 019 144, a hospital bed is described that has a height-adjustable lifter arranged on the mattress frame. With the help of the height-adjustable lifter, the mattress frame with the patient lying on top can be brought from the normal bed height to a care height that makes it easier for personnel to treat the patient in need of care.

For adjusting the height, the known bed has an electric motor that drives a threaded spindle via a worm gear. The threaded spindle extends between the lifter foot and the lifter head, in order to extend the lifter accordingly in height. The drive is self-locking. The electric motor is a low-voltage DC motor. The power-supply voltage is approximately 24 VDC.

With the known bed, patients that weigh up to a structurally predetermined maximum body weight can be raised and lowered. The structural limit is essentially defined by the lifting force of the electric motor that is used.

### OBJECTS AND SUMMARY OF THE INVENTION

In view of the foregoing, a general object of the invention is to provide a hospital bed that can raise and lower patients having a relatively larger body weight.

The hospital bed according to the invention has a height-adjustable lifter. For adjusting the height of the base, two electric motors are provided which work kinematically in parallel. Because these electric motors are self-locking due to the threaded spindle drive, if no countermeasures are taken, twisting can occur that can damage the bed and the motors. Due to the stiffness of the lever mechanism of the base, small path differences in the electric motors are sufficient to cause such damage.

To prevent this, the two electric motors in the hospital bed according to the invention are electrically connected in series. This circuit-related arrangement allows the mechanical load of the two motors to automatically be made symmetrical. The motor having the greater mechanical load exhibits a reduction in rotational speed, even if it is small. This reduces the counter-EMF in this motor, an as a result the drive voltage available for the other motor becomes higher. This higher voltage allows the rotational speed of the less strongly loaded motor to increase accordingly, until both motors are loaded equally.

Experience has shown that this symmetry is paradoxically also possible when the two motors are coupled very rigidly to each other and the mechanical work is output via threaded spindle gear mechanisms that are actually self-locking in practice.

The symmetry on the electrical side ensures that both motors deliver approximately the same mechanical output, which is equivalent to both motors generating approximately the same force for lifting the patient. This method prevents, in particular, continued twisting, which can occur when one motor leads the other motor. The leading motor would always be forced to carry a predominant portion of the patient weight.

When reading the description of the preferred embodiment, those skilled in the art will appreciate that a series of modifications can be made based on specific circumstances. In addition, other combinations are conceivable. All conceivable embodiments cannot be described herein without unnecessarily increasing the length of the description of the preferred embodiments.

Other objects and advantages of the invention will become apparent upon reading the following detailed description and upon reference to the drawings, in which:

### BRIEF DESCRIPTION OF THE DRAWINGS

FIG. 1 is a perspective view of an illustrative hospital bed according to the present invention in a bed position.

FIG. 2 is a perspective view of the hospital bed of FIG. 1 in a chair position.

FIG. 3 is a partially exploded side view of the lifter of the hospital bed according to the invention.

FIG. 4 is a schematic top view of the sub-frame of the lifter of FIG. 3.

FIG. 5 is a schematic circuit diagram of the basic circuit for making the load distribution in the two lifter motors symmetric.

While the invention is susceptible of various modifications and alternative constructions, a certain illustrative embodiment thereof has been shown in the drawings and will be described below in detail. It should be understood, however, that there is no intention to limit the invention to the specific form disclosed, but on the contrary, the intention is to cover all modifications, alternative constructions, and equivalents falling within the spirit and scope of the invention.

### DESCRIPTION OF THE PREFERRED EMBODIMENTS

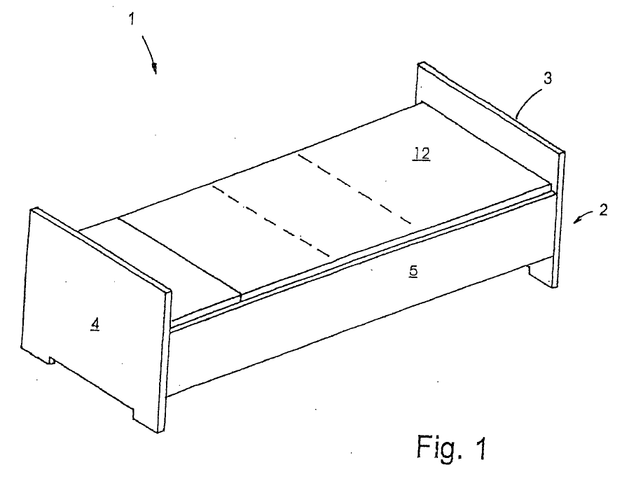

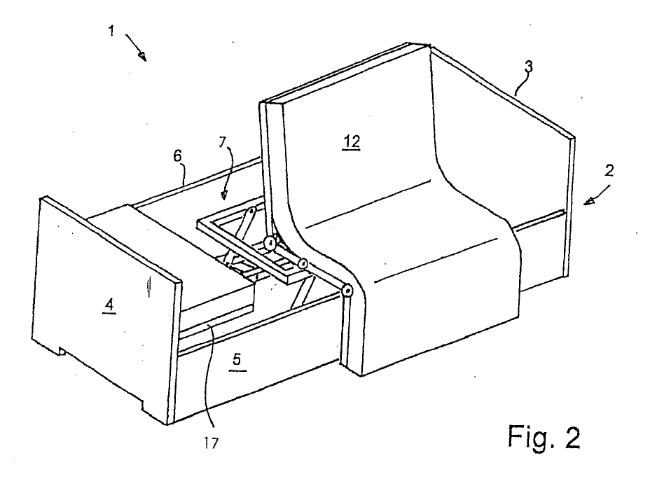

Referring now to the drawings, an illustrative hospital bed 1 is shown in the reclining position in FIG. 1 and in the sitting or chair position in FIG. 2. The hospital bed 1 has a bed frame 2 with a head part 3, a foot part 4, and side walls 5 and 6. As shown, the side wall 5 facing a viewer of FIGS. 1 and 2 is located in the reclining position at a distance from the floor, producing a gap between the bottom edge of the side wall 5 and the floor. This gap allows the caregiver to place the tips of his or her feet under the bed. The side wall 5 is supported so that it can move and can be guided into a shifted-down position in the chair position of the hospital bed 1, as can be seen in FIG. 2. The special mounting of the side wall 5 is explained in detail, for example, in DE 199 12 937 A1.

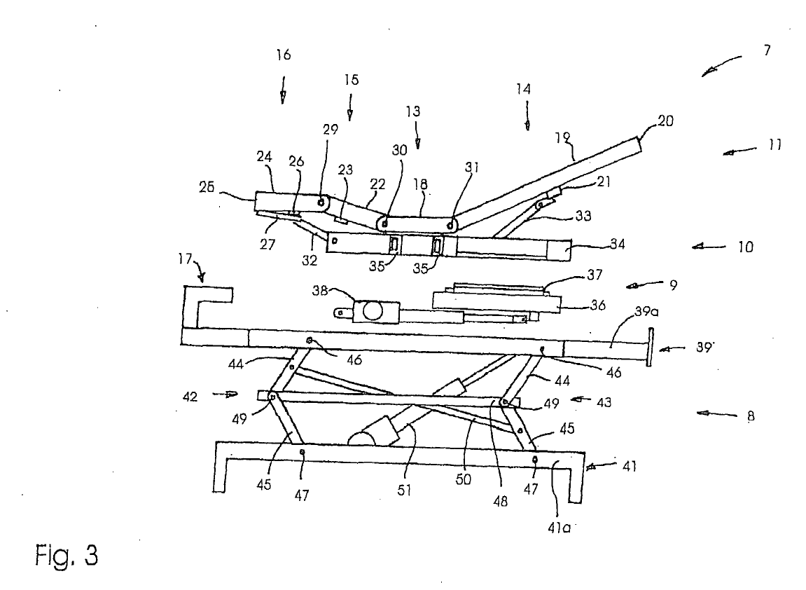

Within the bed frame 2 there is a bed lifter 7, as shown in FIG. 3. The bed lifter 7 includes a height-adjustable base 8 having a head on which a rotary hinge 9 with a vertical rotational axis is mounted, an intermediate frame 10, and a reclining frame 11 on which a mattress 12 is arranged. The reclining frame 11 is rectangular when viewed from the top.

The reclining frame 11 is divided into a central section 13 that is connected rigidly to the intermediate frame 10, a rear section 14 that is hinged to the central section 13, an upper-leg section 15 that is also hinged to the central section 13, and a lower-leg section 16. The lower-leg section 16 is hinged to the end of the upper-leg section 15 facing away from the central section 13. The hinge axes, about which the sections 14, 15, 16 can move relative to the central section 13, extend horizontally. Finally, the reclining frame 11 also includes a foot section 17 that is connected rigidly and directly to the base 8.

The central section 13 of the reclining frame 11 has two longitudinal beams 18 that run parallel to each other and are spaced apart from each other a distance corresponding to the width of the hospital bed 1. Because FIG. 3 is a side view, the visible longitudinal beam 18 hides the associated longitudinal beam of the central section 13 which lies behind it.

The back section 14 is bounded by a beam 19 and another beam, which is parallel to the first beam and is not visible in FIG. 3. The beam 19 is hinged on the beam 18 while the hidden beam is connected to the longitudinal beam parallel to the longitudinal beam 18. The two beams 19 of the back section 14 are connected to each other at the top end at 20 via a transverse beam. In addition, another transverse bar 21 connects the two longitudinal beams 19 at the bottom side.

The upper-leg section 15 is also bounded by two longitudinal beams, of which only one longitudinal beam 22 can be seen. The other longitudinal beam is hidden by the longitudinal beam 22. The two longitudinal beams 22 are connected by a cross bar 23. The cross bar 26 runs approximately at the middle of each longitudinal beam 22 on the bottom side.

Finally, the lower-leg section 16 is also bounded by two longitudinal beams, of which only the longitudinal beam 24 can be seen in FIG. 3. The two longitudinal beams 24 are connected to each other at the bottom end at 25 via a transverse bar. In addition to this transverse bar, the two longitudinal beams 24 are connected by a bar 26, which is attached to two parallel guide rails 27 that reach up to the bottom end 25. As shown, they run at an angle to the longitudinal beam 24, so that they converge in the direction towards the foot end 25. The separation distance of the two guide rails 27 is significantly smaller than the separation distance of the two longitudinal beams 24. Relative to these beams, the guide rails 27 are offset by approximately 20 cm to the inside.

All of the longitudinal beams 18, 19, 22, and 24 carry pegs pointing toward the middle of the bed in order to connect rubber molded parts to the longitudinal beams 18, 19, 22, and 24 The rubber molded parts, in a known way, anchor spring rods extending over the width of the reclining frame 11. The hinges, which are connected on each side of the bed 1 to adjacent longitudinal beams 18, 19, 22, 24, are shown schematically at 29, 30, and 31.

The lower-leg section 16 can be raised or lowered by means of an electric motor. The electric motor is drivingly coupled with a lever 32 and is located in the intermediate frame 10. Another electric motor 33 is supported in the intermediate frame 10 and leads to the transverse bar 21. In this way, the back section 14 can be raised or lowered.

The two longitudinal beams 18 of the central part 13 are connected rigidly to the intermediate frame 10. The intermediate frame 10 is assembled from square tubes welded to each other to form a rectangular frame. Of these tubes, only one square tube 34 can be seen in FIG. 3. The parallel square tube is hidden by the square tube 34.

The rectangular frame is narrower than the distance of the longitudinal beams 18 from each other. In total, four extension arms 35, of which two carry a longitudinal beam 18, are welded to the parallel square tubes 34. The extension arms 35 run horizontally and perpendicular to the longitudinal axis of the hospital bed 1.

The rotary hinge 9 connects the intermediate frame 10 to the height-adjustable base 8. The rotary hinge 9 is assembled from a ring 36 and a center pivot plate 37 mounted so that it can rotate in the ring 34. The center pivot plate 37 is screwed to the intermediate frame 10 via screws. The specific construction of the rotary hinge 9 is explained in DE 102 50 075 A1, which is incorporated herein by reference.

By means of the rotary hinge 9, the intermediate frame 10 can rotate relative to a vertical rotational axis together with the reclining frame 11. The rotation is effected by an electric motor 38, which has one end supported on the base 8 and on the other end supported on the center pivot plate 37.

The height-adjustable base 8 includes an upper frame 39, and also a lower frame 41, composed of square tubes appropriately welded to each other, of which two parallel square tubes form the longitudinal beams 39a and 41a. The upper frame 39 is supported on the lower frame 41 by a total of four knee lever pairs 42 and 43. The rotary hinge 9 is connected to the upper frame 39. The knee lever pairs 42, 43 are each located next to one longitudinal side of the base 8, so that the corresponding knee lever pairs 42, 43 cannot be seen on the other longitudinal side in the side view of FIG. 3.

The knee lever pair 42, 43 is assembled from an upper knee lever arm 44 and a lower knee lever arm 45. Each knee lever 42, 43 is connected in an articulated way, by a hinge 46 with a horizontal axis, to the upper or lower frame 39, 41, on the associated side of the bed. All of the axes of the hinges 46 are parallel to each other. The axes of the hinges 46 are coaxial with the hinges of the not visible knee lever 42, 43.

Hinges 47 connect the knee lever pairs 42, 43 to the lower frame 41. The axes of the hinges 47 are parallel to the axes of the hinges 46, with the axes of the hinges 46, 47, which correspond to each other on the two sides, being coaxial to each other.

The two knee lever pairs 42, 43 on each side of the base 8 are coupled to each other by an associated horizontal coupling bar 48. Each coupling bar 48 is connected in a hinge-like way to the knee joint 49 of each knee lever pair 42, 43, as shown.

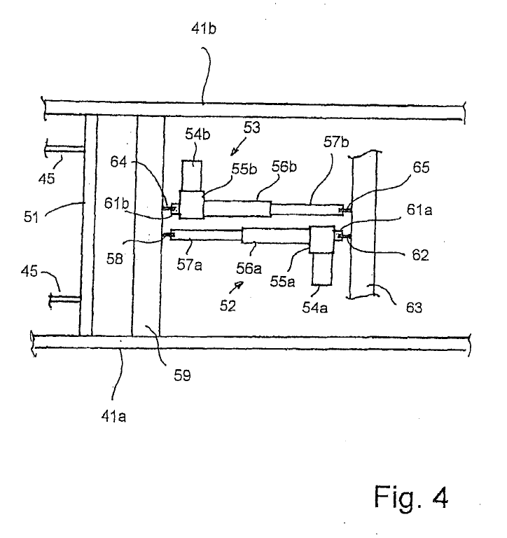

Finally, on each side of the base 8, a diagonal coupling bar 50 connects the upper knee lever arm 44 of the knee lever pair 42 to the lower knee lever arm 45 of the knee lever pair 43. At least the knee levers 45 aligned with each other on the two sides of the bed at the foot end are connected to each other by a shaft, of which only the shaft 51 can be seen in FIG. 4. The same applies for the two lower knee levers 45 at the head end.

As shown in FIG. 4, two spindle lifting drives 52 and 53 are provided for adjusting the height of the lifter 8. The spindle lifting drive 52 includes a permanently excited electric motor 54a and a worm gear contained in a gear housing 55a. An outer telescoping tube 56a, in which an inner telescoping tube 57a is guided so that it can move longitudinally, connects to the gear housing 55a of the worm gear. The inner telescoping tube 57a is moved back and forth in a known way by a threaded spindle located in this tube.

The inner telescoping tube 57a is anchored by a bracket 58 on a bottom transverse beam 59 so that it can pivot. The cross beam 59 extends next to the shaft 51, i.e., next to the lower ends of the two knee lever arms 45.

Another connection yoke 61a is provided next to the gear housing 55a in extension of the inner telescope tube 57a. This connection yoke 61a is anchored on a bracket 62 so that it can pivot. The bracket 62 sits on a cross beam 63 that extends between the longitudinal beams 39a of the upper lifter frame 9.

The spindle lifting drive 53 lies mechanically parallel to the spindle lifting drive 52 and is constructed from the same components. Accordingly, the construction and structural elements appearing there are provided with the same reference symbols and the added character b. The spindle lifting drive 53 extends between brackets 64 and 65 that are provided on the bottom cross beam 59 and the upper cross beam 63, respectively.

With reference to FIG. 4, it is not difficult to see that each irregularity in the travel of the two spindle lifting drives 52 and 53 leads to twisting in the lifter 8, with the consequence that only the leading motor would receive the load during the lifting. In this respect, there is a large risk of overloading this motor mechanically and destroying its drive parts.

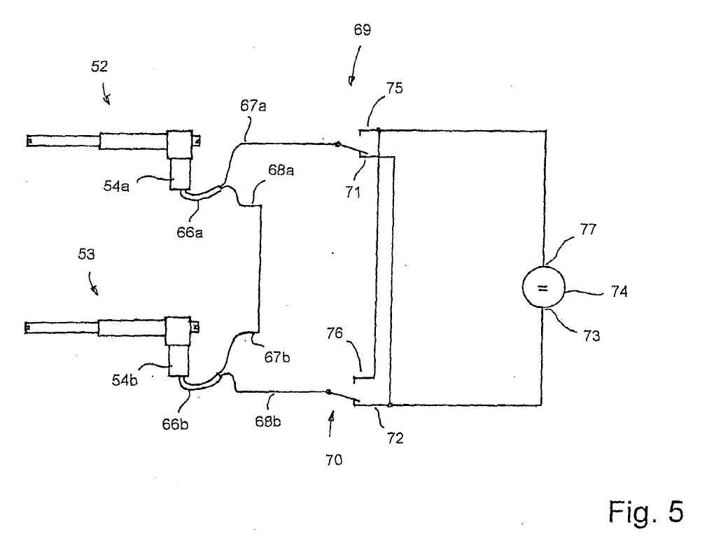

To synchronize the two spindle lifting drives, a circuit arrangement according to FIG. 5 can be provided. The electric motors 54a and 54b and the two spindle lifting drives 52 and 53 involve permanently excited DC motors. It is supplied with power via two two-pin connection cables 66a and 66b. Thus, the spindle lifting drive 52 includes two electrical connections 67a and 68a and the other spindle lifting drive 53 includes the electrical connections 67b and 68b.

The two electric motors 54a and 54b are electrically connected in series, i.e., the motor current input 68a is connected to the motor current input 67b. The motor current input 67a is led to a moving contact of a pushbutton 69, while the current input 68b is connected to a moving contact of another pushbutton 70. Their stationary contacts 71 and 72 together contact a connection 73 of a voltage or current source 74.

The two pushbuttons 69 and 70 have additional working contacts 75 and 76, which are also electrically connected to each other and which contact a second connection 77 of the voltage source 74.

The illustrated position is the home position of the two pushbuttons 69, 70 and leads to the result that the two electric motors 54a and 54b of the spindle lifting drives 52, 53 are not powered.

When the pushbutton 69 is pressed, the current input 67a of the series circuit of the two electric motors 54a and 54b contacts the connection 77 of the DC voltage source 74, while the other current connection 68b is connected to the connection 73. Therefore, the two spindle lifting drives 52, 53 are set in motion, for example, in the direction for deploying or extending the lifter 8 in the same direction.

When the pushbutton 69 is released and the other pushbutton 70 is pressed, the current input 68b is connected to the connection 77 in the voltage source 74, while the current input 67a of the series circuit of the two spindle lifting drives 52 and 53 remains connected to the connection 77 of the voltage source 74. In this way, the series circuit of the two spindle lifting drives 52, 53 can be set in motion, for example, in the direction for retracting the lifter 8. Based on the circuit shown, the load distribution is automatically made symmetric between the two spindle lifting drives 52 and 53.

The following is an explanation of the operation of the circuit although the theory of how the circuit functions may not be completely understood. In the following explanation, it shall be assumed that, for example, when the button 69 is pressed to raise the lifter, the spindle lifting drive 52 is in a position in which it would lead the spindle lifting drive 53. Such a situation can occur when the lifter 8 starts from the lower mechanical end position. The lead initially causes an increased load acceptance compared to the spindle lifting drive 53. Because of the higher loading of the spindle lifting drive 52, the rotational speed of the associated driving electric motor 54a is slightly lower than the rotational speed of the other electric motor 54b. Therefore, the counter EMF generated by the armature of this motor 54a is smaller than the counter EMF of the armature of the electric motor 54b. In this way, the current through the series circuit of the motors can increase. However, because the motor 54a is loaded more strongly, its rotational speed can increase less quickly than that of the less loaded motor 54b. In this way, the less loaded electric motor 54b can catch up in terms of travel. The motor 54b is braked in acceleration only when its extended position overtakes that of the initially more heavily loaded electric motor 54a.

According to the elasticity against which the two spindle lifting drives 52 and 53 work, this compensation play repeats alternately until, after a few alternations, the load is distributed symmetrically between the two motors 54a, 54b, and both generate equal force for extending the lifter 8.

Based on the centrifugal mass of the armature of the two electric motors 54a and 54b, a certain overshoot occurs after reaching the equilibrium state, which causes the searching described above. The searching dies away, however, within a short time after a few overshoots.

So that the desired target can be achieved, the motors 54a, 54b also must essentially match in terms of the significant structural details for the force generation and centrifugal masses, since both motors 54a, 54b should generate the same force. The direction of rotation, however, plays no role. Preferably, maximum loading is to be reached when the nominal voltage of each of the two spindle lifting drives 52, 53 is half as great as the output voltage of the current source 74.

The invention has been described in connection with a rotating hospital bed. It is understood, however, that the ability to rotate can also be eliminated and the invention can also be applied to a normal hospital bed.

To increase the lifting capacity of a hospital bed and to be able to lift heavier patients, two drive motors are used in the height-adjustable lifter. The two drive motors are installed so that they work in parallel mechanically. To achieve a symmetric load distribution between the two motors, they are electrically connected in series and are powered from a common voltage source as a series circuit.

1-12. (canceled)

13. A hospital bed comprising: a height-adjustable lifter, a first and a second electric motor for adjusting the lifter, wherein the first and second electric motors work in parallel mechanically and are connected in series electrically, and a current source (74) for supplying power to the electric motors.

14. The hospital bed according to claim 13, wherein the first and second electric motors are each equipped with a threaded spindle drive.

15. The hospital bed according to claim 13, wherein the first and second electric motors are permanently excited DC motors.

16. The hospital bed according to claim 13, wherein a nominal voltage of each of the first and second electric motors is equal to half the nominal voltage of the current source.

17. The hospital bed according to claim 13, wherein the first and second electric motors are structurally identical.

18. The hospital bed according to claim 13, wherein each of the first and second electric motors drives a respective threaded spindle gear mechanism.

19. The hospital bed according to claim 17, wherein the threaded spindle gear mechanisms associated with the first and second electric motors are structurally identical.

20. The hospital bed according to claim 13, wherein a control circuit is provided between the current source and the first and second electric motors there is a control circuit for changing the polarity of the current fed to the first and second electric motors.

21. The hospital bed according to claim 20, wherein the control circuit is provided with a hand-controlled switch for turning the current for the first and second electric motors on from an OFF state with one polarity or the opposite polarity.

22. The hospital bed according to claim 20, wherein the control circuit has only one common current output for both the first and second electric motor.

23. The hospital bed according to claim 13, wherein the lifter has a lifter foot and a lifter head.

24. The hospital bed according to claim 23, wherein the lifter foot has a first motor coupling bar and the lifter head has a second motor coupling bar that lies parallel to the first motor coupling bar of the lifter foot, and that the first and second electric motors are anchored with one end on one of the first and second motor coupling bars and with the other end on the other of the first and second motor coupling bars.
